(19) United States
(12) Patent Application Publication
(10) Pub. No.: US 2021/0173911 A1
(43) Pub. Date: Jun. 10, 2021

(54) ON-BOARD DEVICE

(71) Applicant: KABUSHIKI KAISHA TOKAI RIKA DENKI SEISAKUSHO, Aichi (JP)

(72) Inventors: Yosuke OHASHI, Aichi (JP); Rijin OWAKI, Aichi (JP); Fumitaka YOSHIKAWA, Aichi (JP); Yuji FUKANO, Aichi (JP)

(21) Appl. No.: 16/768,466

(22) PCT Filed: Nov. 16, 2018
(86) PCT No.: PCT/JP2018/042580

§ 371 Date: May 29, 2020

(30) Foreign Application Priority Data
Dec. 4, 2017 (JP) 2017-232374

(51) Int. Cl. G06F 21/32; G06F 21/62

(52) U.S. Cl. CPC G06F 21/32; G06F 2221/2111; G06F 2221/2143; G06F 21/6245

(57) ABSTRACT

An on-board device includes a storage unit that stores personal information of a user registered to a vehicle, and a control unit that deletes the personal information of the user by controlling the storage unit when the vehicle has stayed at a certain location for a predetermined period.

### CROSS-REFERENCES TO RELATED APPLICATIONS

The present patent application claims the priority of Japanese patent application No. 2017/232374 filed on Dec. 4, 2017, and the entire contents of Japanese patent application No. 2017/232374 are hereby incorporated by reference.

### TECHNICAL FIELD

The present invention relates to an on-board device.

### BACKGROUND ART

A vehicle anti-theft device is known, which is provided with a mobile device authentication means which authenticates a mobile device based on identification information received from the mobile device, a driver authentication means which acquires driver identification information unique to a driver and authenticates the driver as a pre-registered driver based on comparison with pre-registered driver identification information, an information input means receiving an input of setting information which is information set by the registered driver, and an authentication control means which selects either authentication using the driver authentication means or authentication based on the setting information input by the registered driver and controls start of a vehicle based on an authentication result from the selected authentication and an authentication result provided by the mobile device authentication means (see, e.g., Patent Literature 1).

This vehicle anti-theft device uses biometric information of the driver as the driver identification information.

### CITATION LIST

### Patent Literature

Patent Literature 1: JP 2010/208554 A

### SUMMARY OF INVENTION

### Technical Problem

The vehicle anti-theft device disclosed in Patent Literature 1 has a problem that when, e.g., the owner of the vehicle changes, personal information such as biometric information of a previous owner, which has been left undeleted, is left in the vehicle.

It is an object of the invention to provide an on-board device which is capable of deleting personal information left undeleted after an owner of a vehicle has changed.

### Solution to Problem

According to an embodiment of the invention, an on-board device comprises: a storage unit that stores personal information of a user registered to a vehicle, and a control unit that deletes the personal information of the user by controlling the storage unit when the vehicle has stayed at a certain location for a predetermined period.

### Advantageous Effects of Invention

According to an embodiment of the invention, it is possible to provide an on-board device which is capable of deleting personal information left undeleted after an owner of a vehicle has changed.

### BRIEF DESCRIPTION OF DRAWINGS

FIG. 1A is a block diagram illustrating an on-board device in an embodiment.

FIG. 1B is an explanatory diagram illustrating a table stored in the on-board device in the embodiment.

FIG. 2A is an example block diagram illustrating a vehicle communication system including the on-board device in the embodiment.

FIG. 2B is an explanatory diagram for explaining a registered location in the embodiment.

FIG. 3 is a flowchart showing an operation of the on-board device in the embodiment.

### DESCRIPTION OF EMBODIMENTS

### Summary of the Embodiment

An on-board device in an embodiment has a storage unit that stores personal information of a user registered to a vehicle, and a control unit that deletes the personal information of the user by controlling the storage unit when the vehicle has stayed at a certain location for a predetermined period.

When the vehicle has stayed at a certain location for a predetermined period, this on-board device deletes personal information left in a vehicle by determining that the owner of the vehicle has changed. Therefore, unlike when such a configuration is not adopted, personal information left undeleted can be deleted after an owner of a vehicle has changed.

### Embodiment

### (General Configuration of On-Board Device 1)

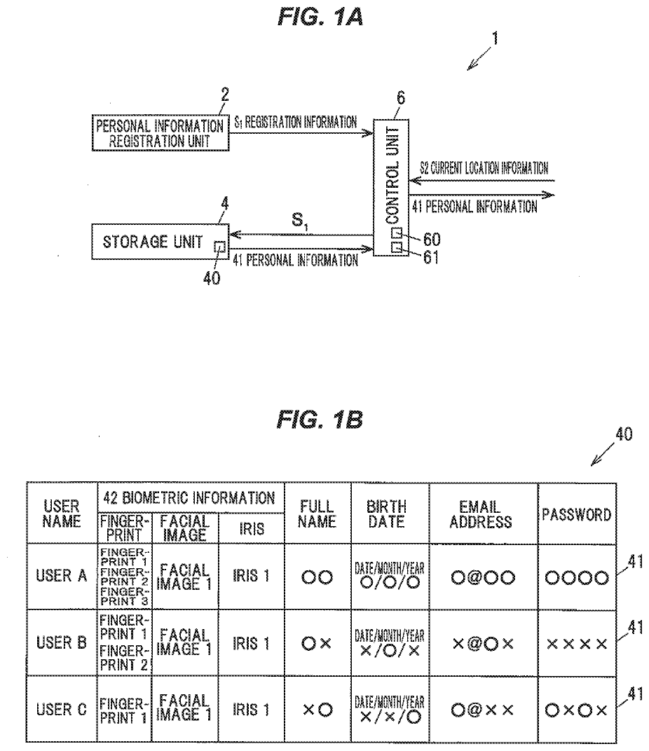

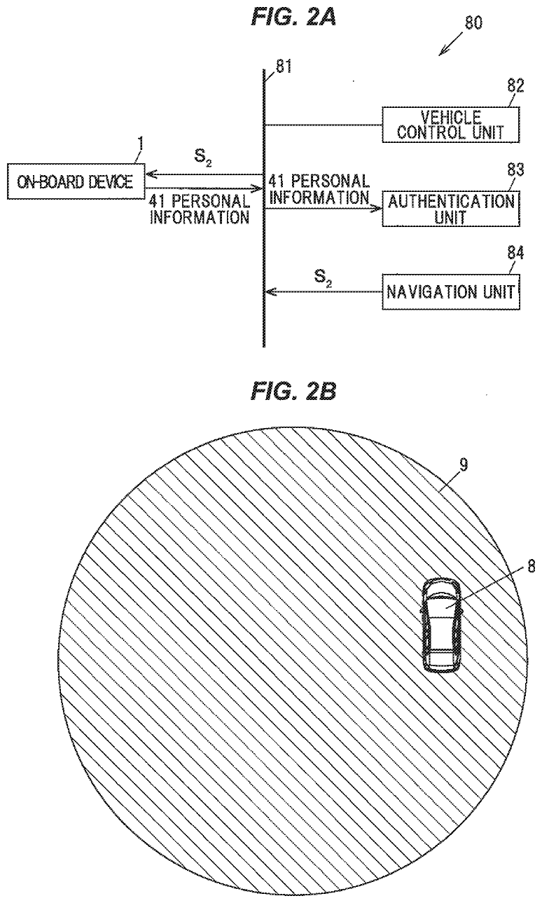

FIG. 1A is a block diagram illustrating an on-board device in an embodiment, and FIG. 1B is an explanatory diagram illustrating a table stored in the on-board device in the embodiment. FIG. 2A is a block diagram illustrating a vehicle communication system including the on-board device in the embodiment, and FIG. 2B is an explanatory diagram for explaining a registered location in the embodiment. In FIGS. 1A and 2A, flows of main signals and information are indicated by arrows.

An on-board device 1 is mounted on a vehicle 8 to manage personal information 41 of users including the owner of the vehicle 8. The vehicle 8 here is used by, e.g., plural users (User A to User C, as an example), as shown in FIG. 1B.

The on-board device 1 has, e.g., a storage unit 4 which stores the personal information 41 of the users registered to the vehicle 8, and a control unit 6 which deletes the personal information 41 of the users by controlling the storage unit 4 when the vehicle 8 has stayed at a certain location for a predetermined period.

It is also configured that, when the vehicle 8 has stayed at a predetermined registered location 9 as the certain location for a predetermined period, the control unit 6 deletes the personal information 41 of the users by determining that the owner of the vehicle 8 has changed.

The personal information 41 of each user includes at least biometric information 42 of the user. As an example, the biometric information 42 includes fingerprint, vein, facial image, iris, etc., used to create a biometric authentication template. As an example, the biometric information 42 in the present embodiment includes fingerprint, facial image and iris shown in FIG. 1B.

The on-board device 1 is further provided with, e.g., a personal information registration unit 2 which receives registration of the personal information 41, as shown in FIG. 1A.

The on-board device 1 is also configured to exchange, e.g., the personal information 41, etc., via an in-vehicle LAN (Local Area Network) 81 in a vehicle communication system 80, as shown in FIG. 2A.

As an example, the vehicle communication system 80 is configured that the on-board device 1, a vehicle control unit 82, an authentication unit 83 and a navigation device 84 are electromagnetically connected via the in-vehicle LAN 81.

The in-vehicle LAN 81 is, e.g., an in-vehicle network such as CAN (Controller Area Network) or LIN (Local Interconnect Network) which enables reciprocal exchange of signals and information by wire or wirelessly.

The vehicle control unit 82 is, e.g., a microcomputer composed of a CPU (Central Processing Unit) performing calculation and processing, etc., of the acquired data according to a stored program, and a RAM (Random Access Memory) and a ROM (Read Only Memory) which are semiconductor memories, etc. The vehicle control unit 82 comprehensively controls, e.g., electronic devices such as sensors mounted on the vehicle 8.

The authentication unit 83 performs authentication using, e.g., the biometric information 42 of the user. As an example, the authentication unit 83 is mounted on a switch device for giving an instruction to turn on/off a drive system of the vehicle 8. In this case, the authentication unit 83 reads, e.g., a fingerprint or vein of an operation finger operating the start switch and compares it with a template which is stored in the storage unit 4 of the on-board device 1, acquired as the personal information 41 and used for authentication of the fingerprint or vein. Alternatively, as an example, the authentication unit 83 may be configured to use facial image or iris of the biometric information 42 to perform authentication for an electronic device other than the start switch.

The navigation device 84 measures, e.g., the current latitude/longitude of the vehicle 8 by using a GPS (Global Positioning System), etc., generates current location information S₂ including the measured latitude/longitude as the current location and outputs it to the on-board device 1. The current location information S₂ is output, e.g., when the drive system of the vehicle 8 is stopped.

### (Configuration of the Personal Information Registration Unit 2)

The personal information registration unit 2 is used to register the personal information 41. As an example, the personal information registration unit 2 is configured to register user's information such as fingerprint, facial image, iris, full name, birth date, email address, password, etc., as shown in FIG. 1B. However, registrable information is not limited thereto and may include vein, pulse rate, blood pressure or residential address, etc.

Text data such as full name, birth date and email address is registered using a touchpad or a virtual keyboard, etc. Biometric information such as fingerprint, facial image, iris is registered, e.g., as follows.

Fingerprint is registered using, e.g., a sensor configured to read the fingerprint pattern, such as optical, capacitive, electrical field intensity measurement, pressure-sensitive, or thermal, etc.

Vein of an operating finger or palm is registered using, e.g., a sensor configured to read the vein pattern based on reflection of emitted infrared light.

Facial image is registered using, e.g., a sensor configured to read an uneven shape on a subject based on depths at plural measurement points on the captured subject.

Iris is registered using, e.g., a sensor configured to read an iris by emitting infrared light and processing the captured image.

The personal information registration unit 2 generates and outputs, e.g., registration information S₁ based on information to be registered.

### (Configuration of the Storage Unit 4)

The storage unit 4 is constructed from, e.g., a HDD (Hard Disk Drive) or a semiconductor memory, etc. The storage unit 4 in the present embodiment is a semiconductor memory. This semiconductor memory may be a RAM mounted on the control unit 6.

The storage unit 4 is configured to generate, e.g., a table 40 based on the registration information S₁ acquired from the personal information registration unit 2, as shown in FIGS. 1A and 1B.

The table 40 contains, e.g., the personal information 41 including the biometric information 42 associated with each user, as shown in FIG. 1B. In FIG. 1B, the personal information 41 of the user A to the user C, who share the vehicle, are shown as an example.

### (Configuration of the Control Unit 6)

The control unit 6 is, e.g., a microcomputer composed of a CPU performing calculation and processing, etc., of the acquired data according to a stored program, and a RAM and a ROM which are semiconductor memories, etc. The ROM stores, e.g., a program for operation of the control unit 6, registered location information 60 and a time threshold value 61. The RAM is used as, e.g., a storage area for temporarily storing calculation results, etc. The control unit 6 also has, inside thereof, a means for generating a clock signal, and operates and measure time based on the clock signal.

The registered location information 60 is information about the predetermined registered location 9 at which the personal information 41 is deleted. The predetermined registered location 9 is a vehicle retailer, as an example. The vehicle retailer is, e.g., a dealer or a used-car seller, etc.

When, e.g., the vehicle has stayed at these retailers for a long time, it is highly likely that the owner of such a vehicle has changed. Then, the personal information 41 of a previous owner, when left in such a vehicle, may be abused or may remain as a candidate biometric information 42 for authentication and result in that authentication takes long time. For this reason, after a predetermined period of time has elapsed since the vehicle moved to the retailer (the registered location 9), the control unit 6 deletes the personal information 41 which has been left undeleted.

The time threshold value 61 is a threshold which represents the predetermined period. The time threshold value 61 is one month, as an example. In other words, the control unit 6 deletes the personal information 41 left undeleted after one month has elapsed since the vehicle moved to the retailer (the registered location 9), as an example.

In detail, the control unit 6 compares, e.g., the current location information S₂, which is acquired via the in-vehicle LAN 81, with the registered location information 60 and determines whether or not the current location of the vehicle 8 is the registered location 9. When the current location is the registered location 9, the control unit 6 starts measuring time. When the measured time exceeds the predetermined period, i.e., exceeds the time threshold value 61, the control unit 6 deletes the personal information 41 from the table 40. Alternatively, the configuration may be such that when the vehicle 8 moves out of the registered location 9 for test drive, etc., for vehicle sales and returns to the registered location 9 within a predetermined period of time (e.g., 1 hour) during when the control unit 6 is measuring time, it is regarded that the vehicle 8 has not moved out of the registered location 9 and the control unit 6 continuously measures time including such the moving time. In addition, time measurement does not necessarily need to be continuous. In case that the vehicle 8 moves out of the registered location 9 temporarily as described above, time measurement may be performed intermittently where such time is excluded from the measured time.

For example, as a method of deleting the personal information 41, the control unit 6 initializes the table 40. That is, the control unit 6 deletes, e.g., all personal information 41 registered by the user A to the user C shown in FIG. 1B.

As shown in FIG. 2B, the registered location 9 is, e.g., not a spot but is set as an area stretched out from a registered latitude/longitude. This area may be set as, e.g., an area in a circle centered at a latitude/longitude of the registered location 9, or may be set as an area based on a building located at the latitude/longitude of the registered location 9.

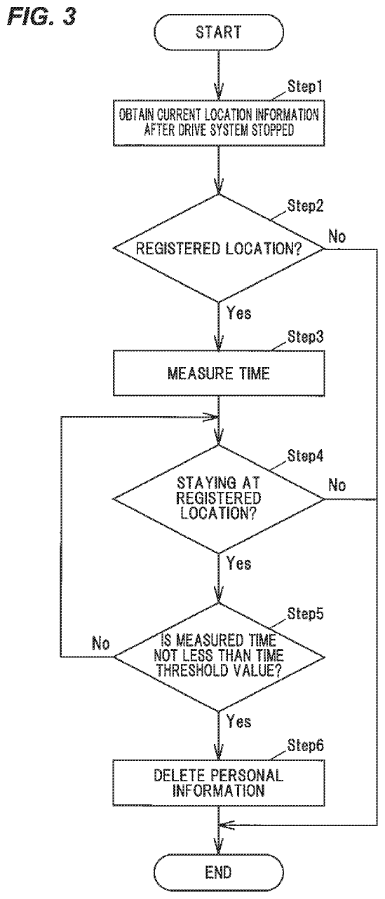

An example of an operation of the on-board device 1 in the present embodiment will be described below along with the flowchart in FIG. 3.

### (Operation)

When the drive system of the vehicle 8 is stopped, the vehicle control unit 82 controls the navigation device 84 which thereby outputs the current location information S₂, which is information about the current location, to the on-board device 1. The control unit 6 of the on-board device 1 acquires the current location information S₂ via the in-vehicle LAN 81 (Step 1).

The control unit 6 compares the current location information S₂ with the registered location information 60 and determines whether or not the current location is the registered location 9. When the current location is the registered location 9 (Step 2: YES), the control unit 6 starts time measurement (Step 3).

The control unit 6 measures time while, e.g., monitoring whether the vehicle 8 is staying at the registered location 9. When the vehicle 8 continuously stays at the registered location 9 (Step 4: YES) and the measured time exceeds the time threshold value 61 (Step 5: YES), the control unit 6 initializes the table 40, i.e., deletes the left personal information 41, by controlling the storage unit 4 (Step 6) and ends the process.

Meanwhile, when the current location is not the registered location 9 in Step 2 (Step 2: NO), the control unit 6 ends the process.

Also when the vehicle 8 moves out of the registered location 9 in Step 4 (Step 4: NO), the control unit 6 ends the process.

Furthermore, when the measured time is less than the time threshold value 61 in Step 5 (Step 5: NO), the control unit 6 moves to Step 4.

### Effects of the Embodiments

The on-board device 1 in the present embodiment can delete the personal information 41 left undeleted after an owner of a vehicle has changed. In detail, when the vehicle has stayed at a certain location (the registered location 9) for a predetermined period, the on-board device 1 deletes the personal information 41 left in the vehicle by determining that the owner of the vehicle has changed. Therefore, unlike when such a configuration is not adopted, the personal information 41 left undeleted can be deleted after an owner of a vehicle has changed. Since the on-board device 1 can delete the personal information 41 which has been left undeleted, user's privacy is protected.

The on-board device 1 can delete not only the personal information 41 but also the biometric information 42 included in the personal information 41 and thus can prevent abuse of the biometric information 42, unlike when biometric information is not deleted and left in the vehicle.

In the on-board device 1, if the biometric information 42 of a previous owner is left even though the owner of the vehicle has changed, this unnecessary biometric information 42 is still used at the time of authentication by verification of the biometric information 42 and this may cause an increase in authentication time. However, since the on-board device 1 can delete the biometric information 42 which has been left undeleted, it is possible to prevent an increase in authentication time.

Although the embodiment of the invention has been described, the embodiment is merely an example and the invention according to claims is not to be limited thereto. This new embodiment may be implemented in various other forms, and various omissions, substitutions and changes, etc., can be made without departing from the gist of the invention. In addition, all combinations of the features described in the embodiment are not necessary to solve the problem of the invention. Further, this embodiment is included within the scope and gist of the invention and also within the invention described in the claims and the range of equivalency.

### REFERENCE SIGNS LIST

1 ON-BOARD DEVICE
2 PERSONAL INFORMATION REGISTRATION UNIT
4 STORAGE UNIT
6 CONTROL UNIT
8 VEHICLE
9 REGISTERED LOCATION
41 PERSONAL INFORMATION
42 BIOMETRIC INFORMATION
60 REGISTERED LOCATION INFORMATION
80 VEHICLE COMMUNICATION SYSTEM
81 IN-VEHICLE LAN
84 NAVIGATION DEVICE

1. An on-board device, comprising:
a storage unit that stores personal information of a user registered to a vehicle; and
a control unit that deletes the personal information of the user by controlling the storage unit when the vehicle has stayed at a certain location for a predetermined period.

2. The on-board device according to claim 1, wherein, when the vehicle has stayed at a predetermined registered location as the certain location for the predetermined period, the control unit deletes the personal information of the user by determining that the owner of the vehicle has changed.

3. The on-board device according to claim 2, wherein the predetermined registered location comprises a vehicle retailer.

4. The on-board device according to claim 2, wherein the predetermined registered location is set as an area stretched out from a registered latitude/longitude.

5. The on-board device according to claim 2, wherein, based on comparison between the predetermined registered location and current location information that is output from a navigation unit after a drive system of the vehicle is stopped, the control unit determines whether or not the current location of the vehicle is the predetermined registered location, and when it is determined that the current location is the predetermined registered location, the control unit measures time while monitoring whether the vehicle is still staying at the predetermined registered location.

6. The on-board device according to claim 1, wherein at least biometric information of the user is stored as the personal information of the user in the storage unit.

7. The on-board device according to claim 6, wherein one or more selected from fingerprint, vein, pulse rate, blood pressure, facial image and iris is/are stored as the biometric information of the user in the storage unit.

8. The on-board device according to claim 1, further comprising a personal information registration unit that receives registration of the personal information of the user,
wherein the personal information of the user acquired from the personal information registration unit is stored in the storage unit.

9. The on-board device according to claim 8, wherein the personal information registration unit resisters at least biometric information of the user as the personal information of the user, and the at least biometric information of the user acquired from the personal information registration unit is stored as the personal information of the user in the storage unit.

10. The on-board device according to claim 9, wherein the personal information registration unit registers one or more selected from fingerprint, vein, pulse rate, blood pressure, facial image and iris as the biometric information of the user, and one or more selected from the fingerprint, the vein, the pulse rate, the blood pressure, the facial image and the iris is/are stored as the biometric information of the user in the storage unit.
